(19) United States
(12) Patent Application Publication
(10) Pub. No.: US 2010/0039252 A1
(43) Pub. Date: Feb. 18, 2010

(54) Timing Device

(76) Inventor: Tony George Barkus, Winnipeg (CA)

Correspondence Address: ADE & COMPANY INC., 2157 Henderson Highway, WINNIPEG, MB, R2G1P9, CA

(21) Appl. No.: 12/441,094

(22) PCT Filed: Jan. 22, 2008
(86) PCT No.: PCT/CA08/00118

§ 371 Date: Mar. 12, 2009

Related U.S. Application Data
(60) Provisional application No. 60/881,522, filed on Jan. 22, 2007.

(51) Int. Cl. G08B 19/00; G08B 23/00; G04F 10/00

(52) U.S. Cl. 340/521; 340/573.1; 368/107

(57) ABSTRACT

A timing device, for indicating to a user a characteristic of a consumable product related to consumption of the product, comprises a printed circuit integrally supporting a processor, a timer, an indicator and a movement sensor thereon. The movement sensor is arranged to sense motion or vibration of the product relative to its surroundings for determining a user interaction with the product. The processor is operable in one mode so that the indicator indicates expiry of the product responsive to detection of user interaction by the sensor once the time interval of the timer has expired. In another mode, the processor is operable so that the indicator is activated responsive to a dosage interval of the timer being expired. In this later mode, the indicator is deactivated responsive to detection of user interaction by the sensor indicative of a dosage being taken.

This application claims priority to U.S. provisional application Ser. No. 60/881,522, filed Jan. 22, 2007.

### FIELD OF THE INVENTION

The present invention relates to a timing device for use with a consumable product, for example medication or food products to be consumed by a user, and more particularly, the present invention relates to a timing device for indicating to the user a characteristic of the product related to consumption of the product, for example for indicating a time interval between dosages or for indicating an expiry date of the consumable product.

### BACKGROUND

There are many forms of medications and the like which require regular dosages to be taken by a consumer of the product in order for the product to be most effective. As it can be difficult to remember to take all dosages at the required times, reminders relating to dosages of medication and the like are known to be desirable. Prior art examples of reminder devices relating to dosages are described in U.S. Pat. Nos. 4,849,948 to Davis et al, 6,633,796 to Pool et al and both 7,138,906 and 6,084,504 to Rosche.

In Davis, in order to maintain a simplified device, only a very brief notification lasting a matter of seconds is provided to the user for reminding the user to take another dosage at each prescribed dosage interval. As there is no means for detecting the interacting of the user with the product when taking a dosage, the only means of saving the battery power in Davis is to only operate the reminder indicator for such a brief period. The brief period may not be sufficient for a user to be adequately notified and missed dosages can accordingly frequently occur.

The patents to Pool and Rosche attempt to overcome the problems of Davis by providing an alarm which remains activated until the user takes action to stop the reminder alarm when taking a dosage. In each instance however a complex mechanical switch of some form is required. The moving parts of the switch result in a higher maintenance product which is subject to mechanical failure and which cannot be easily adapted to any form of packaging. Rosche in particular is limited to a trigger for detecting a user taking a dosage in the form of a complex mechanism mounted in a cap of a container to detect when the cap is unscrewed from the container.

In the field of timing devices for use with a consumable product, it is also desirable for users to be aware of an expiry date of the product to ensure that the product is not continued to be consumed beyond its known shelf life. U.S. Pat. Nos. 7,057,495 belonging to Debord et al. and 5,802,015 belonging to Rothschild et al. disclose examples of expiry date indicators, however in each instance a timer actuates an expiry indicator which remains activated continuously so as to greatly limit the overall life of the device when attempting to limit the battery size and timing device itself for use on various forms of packaging at a reasonable cost.

### SUMMARY OF THE INVENTION

According to one aspect of the invention there is provided a timing device for use with a consumable product, the device comprising:

a timer arranged for determining a time interval;

a sensor arranged to detect an interaction between a user and the consumable product;

an indicator arranged for indicating to the user a consumption characteristic related to consumption of the product;

a processor arranged to determine the consumption characteristic responsive to the timer and the sensor; and

a circuit board commonly supporting the timer, the sensor, the indicator and the processor thereon.

According to another aspect of the present invention there is provided a timing device for use with a consumable product, the device comprising:

a timer arranged for determining a time interval;

a movement sensor arranged to be supported on a package of the consumable product and to detect movement of the package;

an indicator arranged for indicating to the user a consumption characteristic related to consumption of the product; and

a processor arranged to determine the consumption characteristic responsive to the timer and the movement sensor.

By providing a sensor directly on a printed circuit board, and more particularly a movement sensor, for example a motion or vibration sensor, on the circuit board, the status of the indication to a user relating to expiry dates can be indicated only when interaction with the user is sensed. Accordingly the device is dynamic and interactive with a user, as well as providing the advantage of extending the life of the battery. Also, the sensor can be used in a timing device for reminding when dosages should be taken for turning off dosage alarms when user interaction is detected also to provide dynamic user interaction and extend battery life. The configuration of a sensor directly on the printed circuit board has the advantage of being easily manufactured at low cost for ready installation of a very small device on any type of packaging in various forms unseen in the prior art and with unseen functional advantages over the prior art. Also, a lower cost dosage reminder can be provided as compared to prior art timing devices while also enabling an expiry device to have an extended life due to sensor interaction with a user in a reliable and easily implemented manner.

When the indicator comprises a light, there may be provided a translucent housing supporting the timer, the sensor, the indicator and the processor therein in which the translucent housing is arranged to reflect light from the indicator in plural directions.

When there is a package containing the consumable product therein, the timer, the sensor, the indicator, and the processor may be encased by and integrally molded into a housing comprising a replacement component arranged for replacing a component of the package. When the indicator comprises a light, preferably at least a portion of the housing about the indicator is translucent.

The movement sensor may be arranged to detect either a lateral translational movement in any direction, a variation in angular orientation, or an omnidirectional vibration movement of the package upon which the sensor is supported depending on which style of sensor is used.

The processor may be operable in a first mode in which the indicator is activated responsive to detection of user interaction once the time interval has expired and in a second mode in which the indicator is activated responsive to the time interval being expired and in which the indicator is deactivated responsive to detection of user interaction.

In the first mode, the time interval corresponds typically corresponds to an expiration date of the product.

In this instance, the indicator may only be activated for a prescribed period of time responsive to detection of user interaction by the sensor.

The indicator may comprise a first indicator, for example a green light, which is responsive to detection of user interaction by the sensor before expiry of the time interval, and a second indicator separate from the first indicator, for example a red light, which is responsive to detection of user interaction by the sensor after expiry of the time interval.

There may be provided an auxiliary timer actuated responsive to activation of the indicator and arranged to prevent further activation of the indicator until expiry of a prescribed interval of the auxiliary timer.

The time interval of the primary timer may include a duration between a time of manufacture and packaging of the product and a duration of a shelf life of the product from the packaging of the product when it is activated at the time of manufacture.

There may be provided a temperature sensing module arranged for connection to the processor and to sense an ambient temperature so as to alter the time interval before expiry according to the ambient temperature.

In the second mode, the time interval may comprise an interval of time between dosages of the product. In this instance, the indicator may be activated responsive to the time interval being expired and be deactivated responsive to detection of user interaction. The processor is preferably arranged to restart the timer upon each activation of the indicator.

There may also be provided an auxiliary timer arranged to deactivate the indicator once the indicator has been activated for a prescribed duration of the auxiliary timer even if there is no user interaction with the sensor.

The processor is preferably arranged to determine when a prescribed number of dosages has been reached and discontinue further activation of the indicator when the prescribed number of dosages has been reached.

When there is provided a reset switch in communication with the processor, and a plurality of different time intervals corresponding to different intervals of time between different dosages within a prescribed cycle, preferably the reset switch is arranged to both alter a duration of the different time intervals and to reset a starting point of the prescribed cycle.

When a reset switch is in communication with the processor, the processor may be operable in a programming mode in which each actuation of the reset switch over a 24 hour programming period determines a corresponding dosage interval in a subsequent 24 hour operating period in an operating mode in which the indicator is responsive to expiry of each dosage interval.

As described in the accompanying specification, the present invention preferably comprises a new disposable electronic apparatus which is easy to understand and operate and which is interactive with the end-user by either activating a red or green visual alarm and optional audio alarm when movement is detected in elapsed time applications or deactivating a green visual alarm and optional audio alarm in compliance applications when motion or vibration is detected.

The present invention preferably also comprises a new disposable electronic apparatus which can interact with the end-user for other applications other than elapsed time or compliance such as alerting a contest winner through visual and/or audio notification.

The present invention preferably also comprises a new disposable electronic apparatus which can be molded with plastic to form an external attachment to an existing product or insert molded with plastic to form a replacement part for an existing product thereby enabling manufacturers of these products or service providers with an inexpensive but effective electronic monitoring and notification system which is discarded after use.

The present invention preferably also comprises a new disposable electronic apparatus that will be durable and reliably constructed and can be easily integrated into existing manufacturing processes.

The present invention preferably also comprises a new disposable electronic apparatus which is low in cost of manufacture with regard to both materials and labor, and which accordingly is then low in price of implementation by manufacturers of time sensitive and compliance products as well as providers of time sensitive services.

In these respects, the disposable electronic apparatus of the present invention substantially, departs from the conventional concepts and designs of the background art, and in so doing can provide a disposable apparatus with electronic reminders that have a specified life span and functionality, are custom programmed to match the requirements of a specified application and are dynamically interactive with the end user. The present invention further relates to a method which has many advantages over the background art; and many novel features that result in a new Disposable Electronic Apparatus, which is not anticipated, rendered obvious, suggested, or even implied by the background art, either alone or in a combination thereof.

Some embodiments of the invention will now be described in conjunction with the accompanying drawings in which:

### BRIEF DESCRIPTION OF THE DRAWINGS

FIG. 1A is a schematic illustration of a first embodiment of the timing device particularly suited for providing dosage reminders at repeated dosage time intervals.

FIG. 1B is a perspective schematic illustration of a second embodiment of the timing device particularly suited for providing notification of an expired product.

FIG. 2A and FIG. 2B are perspective views a first embodiment of the housing locating the timing device therein before and after attachment to a product packaging in which the timing device is particularly suited for indicating expiry dates.

FIG. 3A and FIG. 3B are perspective views of an embodiment of the housing particularly suited for providing reminders of dosage intervals before and after attachment to product packaging respectively.

FIG. 4 is a perspective view of a further embodiment of the housing comprising a replacement part for existing packaging, which is particularly suited for indicating expiry dates.

FIG. 5 is a perspective view of another embodiment of the housing for replacing an existing component of product packaging and which is particularly suited for use in providing dosage interval remainders.

FIG. 6 is a chart comparing various optional cycles when the timing device is suited for providing dosage interval reminders.

FIG. 7 is a schematic illustration of the method of the timing device of indicating expiry date information.

FIG. 8 is a flow chart of the method of the timing device of indicating dosage interval reminders according to a pre-programmed schedule.

FIG. 9 is a flow chart of the method of the timing device of providing reminders relating to dosage intervals according to a manually set alarm cycle.

FIG. 10 is an electrical schematic representation of one embodiment of the timing device.

FIG. 11 is a perspective view of a first embodiment of product packaging incorporating the timing device therein.

FIG. 12 is another embodiment of product packaging incorporating the timing device therein.

FIG. 13 is a perspective view of another example of product packaging incorporating the timing device therein.

In the drawings like characters of reference indicate corresponding parts in the different figures.

### DETAILED DESCRIPTION

Referring to the accompanying figures there is illustrated a timing device generally indicated by reference numeral 20. The timing device 20 is particularly suited for use with a consumable product, for example medication or food products and the like, for indicating a consumption characteristic of the product related to the consumption of the product.

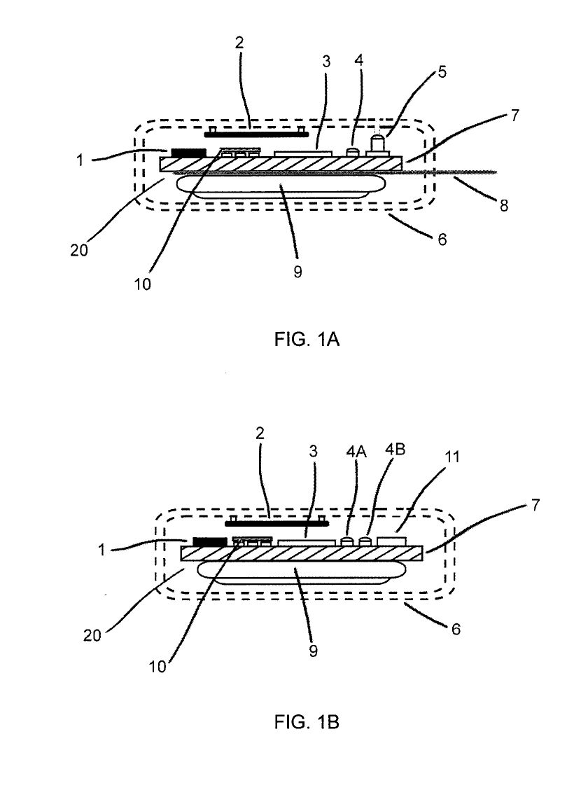

The device 20 according to FIG. 1A or 1B generally comprises a printed circuit board 7 which commonly supports a processor 3, a movement sensor 10, and indicators in the form of lights 4, as well as a timer or timing element 1 arranged for determining a time interval. A battery 9 is also supported on the board 7 for providing electrical power to the components of the device. The components are all commonly supported on the circuit board 7 which is in turn encased within a suitable housing 6 which may take various forms according to the various embodiments described in the following.

For dosage interval applications as in FIG. 1A, an optional speaker 2 can be supported on the circuit board 7 commonly with the other components along with a single reset switch 5 for providing an input to the processor when pressed by the user.

For expiry date applications as in FIG. 1B, an optional speaker 2 can be supported on the circuit board 7. The indicator may comprise both a green LED 4A and a red LED 4B for operation according to the functions described further below.

In each embodiment, the battery is supported on the circuit board opposite the processor for compacting the design such that the device is suitable for application in many forms.

The movement sensor 10 according to a preferred embodiment is arranged to sense motion or vibration and accordingly motion or vibration of the consumable product packaging upon which it is supported, relative to the surroundings, for detecting user interaction between the user and the consumable product. The sensor may take various forms including mechanical switches such as a movable conductive ball or liquid mercury which is displaced between multiple different electrical contacts as the timing device is moved or varied in angular orientation in any manner. Other suitable forms of sensors for detecting motion or vibration of the package relative to the surroundings include various forms of solid state sensors, accelerometers, vibration sensors, or optical elements and the like. In either instance, the sensor is capable of detecting a lateral translational movement, a variation in angular orientation or omni-directional vibration in any direction for sensing a user picking up the package, repositioning the package, or displacing the package containing the consumable product therein even before the package is opened.

In preferred arrangements, the indicator relies primarily on the use of LED lights 4A and 4B according to the embodiment of FIG. 1B and designated by reference character 4 in the embodiment of FIG. 1A. When the indicator comprises a light, the housing 6 is formed of translucent material which surrounds the device so as to also surround the indicator light 4. The translucent housing is thus arranged to reflect light from the indictor into plural directions so that only a very small light is required to generate a large clearly visible visual indicator to the user. By forming the housing of clear plastic material, in some embodiments the device can be integrally molded within the housing such that the battery cannot be replaced and the processor is pre-programmed so that the timing device is accordingly disposable. The simplicity of the construction of the timing device including all of the components including the sensor being supported commonly within the housing minimizes the cost associated with manufacture for further favouring disposability of the timing device.

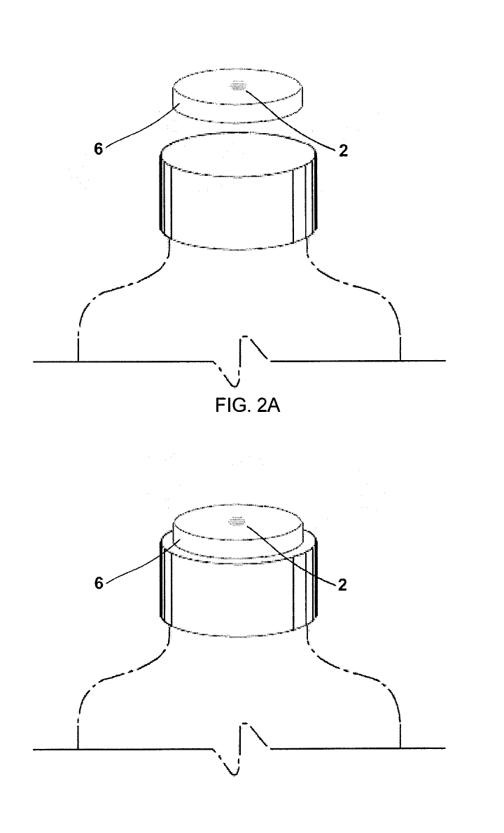

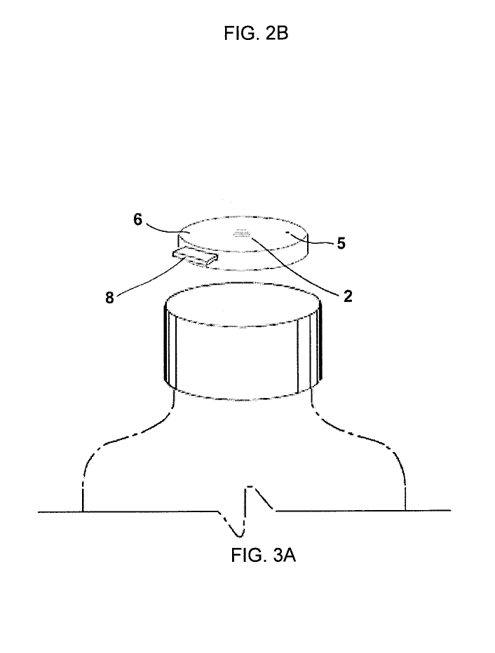

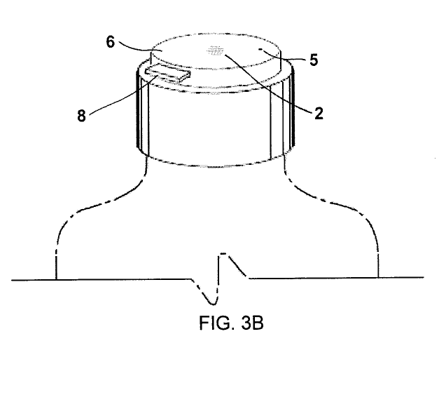

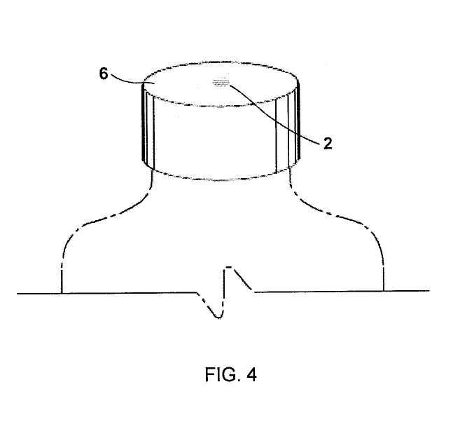

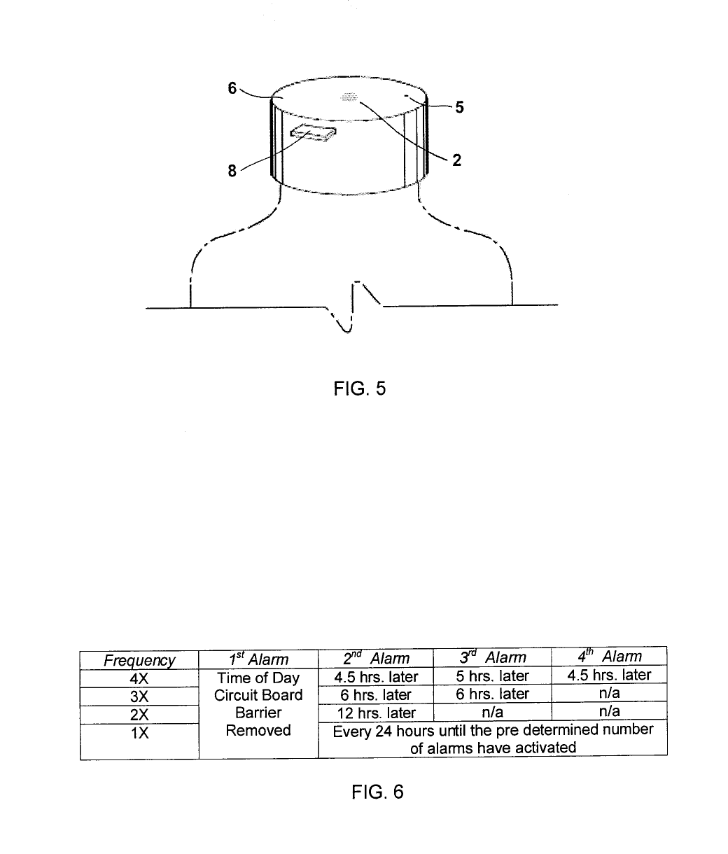

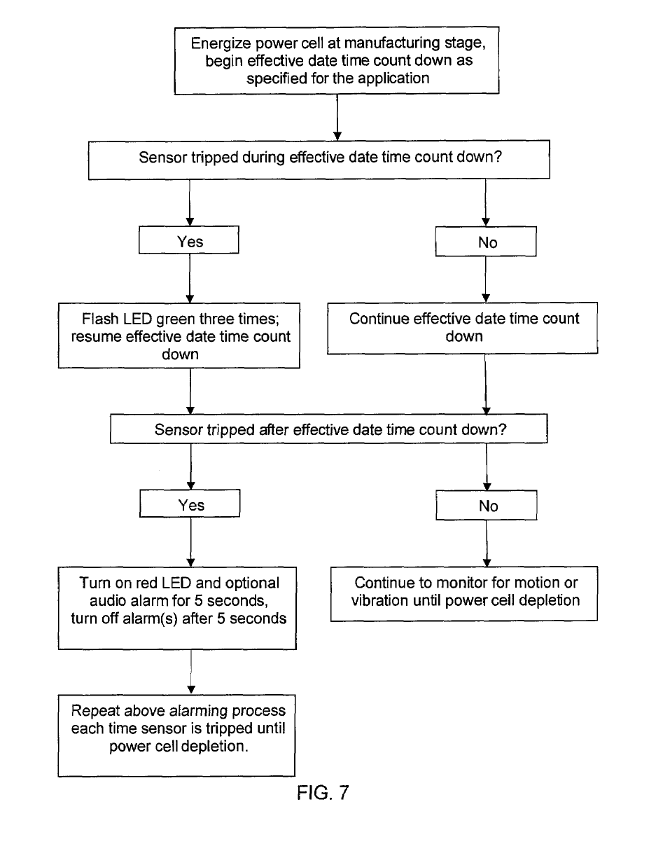

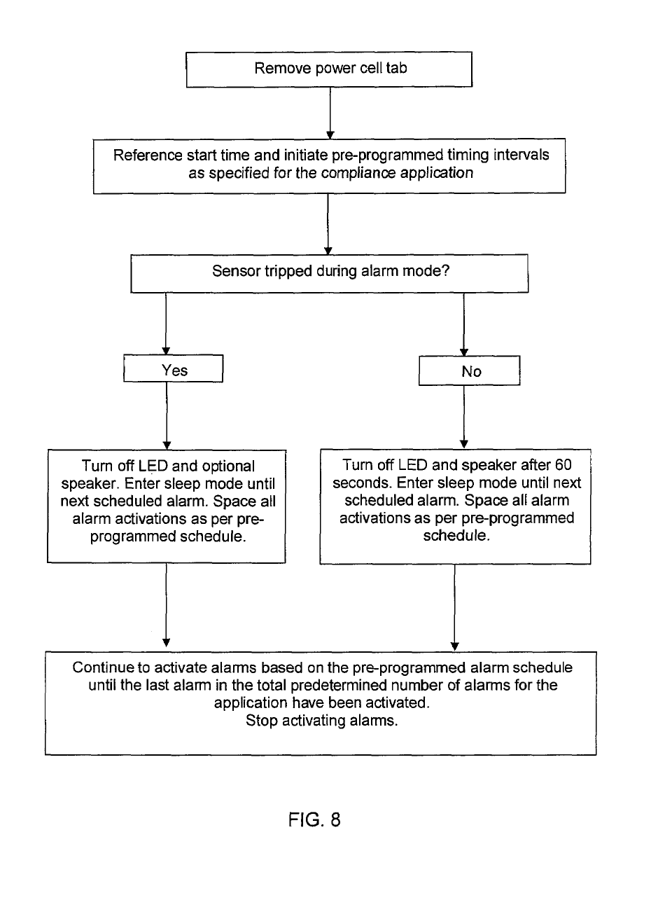

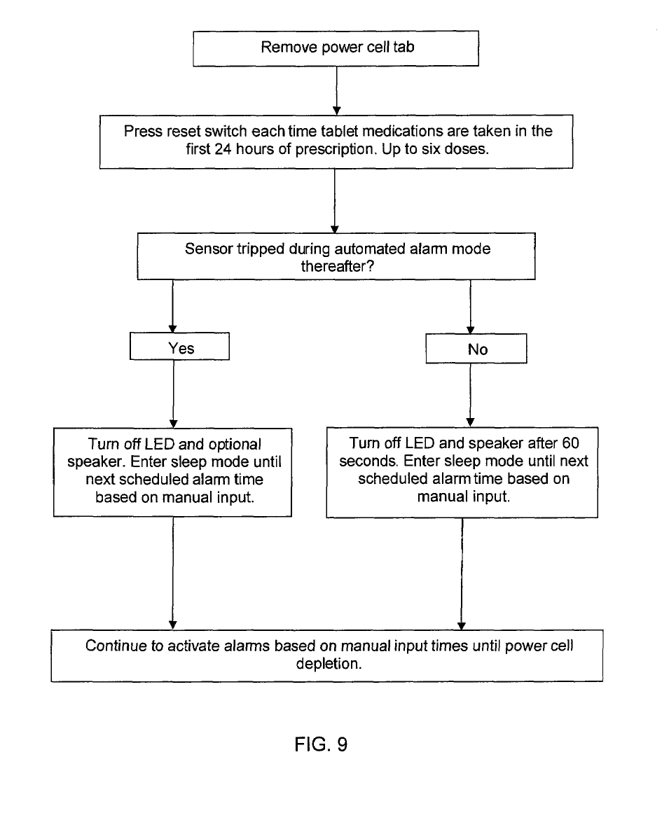

In some embodiments as described in the following, the housing 6 comprises a replacement component for replacing an existing component of a product packaging. For example the housing may comprise an integrally threaded cap for replacing the cap on an existing bottle as shown in FIGS. 4 and 5. Alternatively the housing maybe integrally formed as a replacement part for other forms of product packaging including components of a catheter, an IV bag, an IV syringe, or other forms of medication containers and the like. In yet further arrangements, the compactness of the device permits formation of a small circular shaped housing 6 suitable for fastening to the cap of a bottle for example as shown in FIGS. 2A, 2B, 3A and 3B.

The simple construction of the timing device is readily adaptable to two different modes of operation. In a first mode the processor is operable such that the timer determines an expired shelf life of the product for indicating whether or not the product is expired only momentarily upon the sensor detecting interaction with the user. One of the lights 4A of the embodiment of FIG. 1B thus corresponds to a green light defining a first indicator which is responsive to detection of user interaction by the sensor before the expiry of the time interval to indicate that the product is not yet expired, whereas the indicator light 4B defines a second indicator comprising a red light emitting diode separate from the first indicator and operated by the processor so as to be responsive to detection of the user interaction by the sensor only after the time interval of the timer has expired.

The time interval determined by the timer in the first mode thus corresponds to an expiry date of the product. In this mode of operation the indicators are typically only activated for a very brief prescribed period of time for example comprising only a few flashes each time user interaction is detected by the sensor for conserving the batteries.

An auxiliary timer in this mode may also keep track of a prescribed interval beginning with the activation of the indicator. The processor responds to the auxiliary timer by preventing further activation of the indicator until the prescribed interval of the auxiliary timer expires. For example, to conserve battery strength in a 540-day operating mode, a minimum of 3 hours, as determined by the auxiliary timer, must elapse before the green LED re-activates when the package is picked up or handled by the user. The prescribed interval may correspond to a period of a few hours or any other period of duration which is greater than the period of activation of the indicator so that in the event that the sensor is placed in a location with continuous detection of some movement or vibration with the package, the indicator is prevented from continual operation to prevent excess use of the battery and premature failure of the timing device.

In the first mode, when assembling the timing device including the battery at the time of manufacture, the interval of time determine by the timer begins counting down immediately upon activation by connection to the battery. The interval of time of the timer in this instance thus corresponds to both a duration of time between the time of manufacture of the timing device and the time that the product is packaged in the package with which the timing device is associated in combination with the duration of the shelf life of the product as measured from its time of packaging.

As shown in the embodiment of FIG. 1B, an optional temperature sensing module 11 may be provided which can be also supported on the common printed circuit board for connection to the processor. The temperature sensing module is arranged to sense an ambient temperature and to compensate for any effects that adverse temperature may have on the overall shelf life and expiry date of the product. Accordingly the temperature sensing module is arranged to alter the time interval determined by the timer which corresponds to the shelf life of the product responsive to ambient temperature conditions sensed by the module.

In an alternate mode of operation the time interval determined by the timer comprises a plurality of dosage intervals each corresponding to an interval of time between recommended dosages of the product with which the timing device is associated. In this instance the processor operates the indicator to be activated responsive to each dosage time interval being expired so as to serve to indicate to a user to consume another dosage. The indication to the user continues until either: i) the movement sensor detects motion or vibration of the package and some form of user interaction with the package, or ii) by determination by an auxiliary timer that a prescribed duration of the auxiliary timer has expired corresponding to a limit of activation of the indicator. The limit of activation prevents the indicator from being continuously activated which causes a drain on the battery however instead of only being activated momentarily, the indicator can still be activated for sufficient duration that the user is aware of the dosage indication.

By also providing a sensor which detects user interaction, battery life can also be preserved by turning off the indicator immediately upon detection of the user displacing the package without the user being required to open the package or otherwise manually actuate a reset trigger and the like. In the second mode, the processor is arranged to restart the time and begin a new dosage interval of time to be determined by the time upon each activation of the indicator.

In the second mode, the timing device is also encased in a suitable housing 6 associated with the package having the consumable product therein so as to be well suited to disposability. The processor is typically pre-programmed with a prescribed number of dosages of the product contained within the package with which the device is associated so that the processor can determine when a prescribed number of dosages has been reached and discontinue further activation of the indicator when the prescribed number of dosages has been reached.

The reset switch 5 in the second mode remains in communication with the processor for various uses related to multiple prescribed dosage intervals within a prescribed cycle of the device. For instance when the device includes a plurality of dosage intervals to be taken within a prescribed 24 hour period corresponding to one cycle and the cycle is repeated continually, the reset switch can be used to first alter a duration of any of the dosage intervals and secondly to reset the starting point of the repeating cycle at any given time.

In the second mode, the processor may also be operated in an initial first cycle corresponding to a programming mode to be followed by a plurality of subsequent cycles defining the subsequent operating mode. In the programming mode, during the initial 24 hour period of the initial cycle of dosages, each engagement of the reset switch programs a dosage interval relative to the previous reset switch engagement. Upon the expiry of the initial cycle, the processor automatically switches to the operating mode and activates the indicator by repeating the same dosages set in the programming mode and activating the indicator at the expiry of each subsequent dosage interval.

As described herein, the present invention relates to products or services that have a short-term or long-term time tracking requirement as well as products that require assistance with compliance management and more specifically to a dynamically interactive disposable electronic apparatus for elapsed time monitoring & notification and compliance monitoring & notification where the life span and functionality of each elapsed time and compliance application is pre-determined at the manufacturing stage to match the requirements of an intended application and that once the disposable electronic has performed its specified function within that application, the apparatus stops working, is discarded and then replaced as required.

### Elapsed Time Monitoring & Notification Application Overview

When programmed for elapsed time applications, the disposable electronic apparatus or timing device 20 provides electronically enhanced elapsed time monitoring and notification for products or services that have a short-term or long-term time tracking requirement. The disposable electronic apparatus or timing device 20 first counts down elapsed time as specified by the product manufacturer or service provider and then depending on the elapsed time application, can either activate a red visual alarm and optional audio alarm (if incorporated) automatically or whenever the expired product is handled. A secondary timer turns off unattended activating alarm(s) after a pre-determined amount of time.

### Compliance Application Overview

When programmed for compliance applications, the disposable electronic apparatus or timing device 20 provides electronic compliance notification for products that require assistance with compliance management by activating a green visual alarm and optional audio alarm each time a compliance product needs to be taken. The alarm schedules can be pre-programmed at the manufacturing stage or manually set in use to meet the requirements of the compliance application. Activating alarm(s) are either turned off when the compliance product is handled or by a secondary timer, which turns off unattended activating alarm(s) after a pre-determined amount of time.

### Technical Specifications

This technical specification for the disposable electronic apparatus or timing device 20 is based on using readily available off-the-shelf electronic components. Integrated chip technology, all-polymer chip technology (once all-polymer technology becomes available for third party applications) as well as alternate power supply sources may be considered for use when manufacturing the disposable electronic apparatus.

The controller of the disposable electronic apparatus will generally be a microprocessor containing programmable memory for code storage as well as variable memory, which are used in the execution of the elapsed time and compliance applications. The microprocessor contains a timer, which once stabilized by the crystal or resonator generates the timing intervals for elapsed time tracking such as notification of a perishable product's expiry date for example and for stored pre-programmed alarm schedules or manual alarm setting in compliance applications. The timer also provides the on/off timing for the LED and optional audio alarm. Two output pins are required for the microprocessor, one pin to drive the LED and a second pin to drive an optional audio alarm should audio notification be a requirement in an elapsed time or compliance application.

The operating programs (codes) for tracking elapsed time, activating pre-programmed alarm schedules or manually setting alarms are contained in the non-volatile program memory of the microprocessor. The specified operating program is entered into the memory of the microprocessor electronically when the disposable electronic apparatus is manufactured. Optionally, a manufacturer or service provider could be outfitted with an EPROM burner and the programming code for the disposable electronic apparatus to initiate or customize the operating program as required.

The major components of the device 20 comprise: Crystal or resonator to stabilize unit timing for timer 1 function; Optional audio alarm element 2; Microprocessor 3; LED to function as a visual indicator 4 of alarm state; Reset switch 5 (compliance applications only) allows end users to set alarm times, modify pre-programmed alarm spacings or erase a manually entered or pre-programmed alarm schedule; Translucent plastic housing 6; supplied with the apparatus for external attachment to an existing time sensitive or compliance product; Printed circuit (printed wiring) board 7; Circuit board barrier 8 to keep the battery separated from the electronics until the user wishes to start a compliance regimen (compliance applications only); Power cell (battery) 9 as required to operate the electronics; Movement sensor (10) to either activate an alarm state in elapsed time applications for expired products or clear the alarm state in compliance applications; and temperature sensing module (11) should the expiry date be reliant on ambient conditions

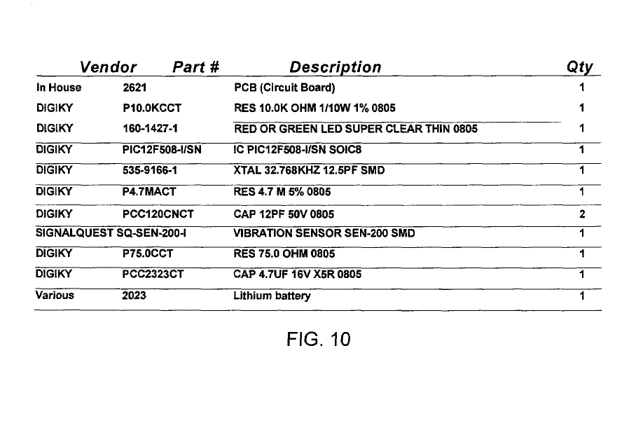

The device according to the present invention in a preferred embodiment as shown in FIG. 10 typically comprises the following components:

| Vendor | Part # | Description | Qty |
|---|---|---|---|
| In House | 2621 | PCB (Circuit Board) | 1 |
| DIGIKY | P10.0KCCT | RES 10.0K OHM 1/10W 1% 0805 | 1 |
| | | RED OR GREEN LED SUPER CLEAR THIN 0805 | |
| DIGIKY | PIC12F508-I/SN | IC PIC12F508-I/SN SOIC8 | 1 |
| DIGIKY | 535-9166-1 | XTAL 32.768 KHZ 12.5 PF SMD | 1 |
| DIGIKY | P4.7MACT | RES 4.7 M 5% 0805 | 1 |
| DIGIKY | PCC120CNCT | CAP 12 PF 50 V 0805 | 2 |
| SIGNALQUEST | SQ-SEN-200-I | VIBRATION SENSOR SEN-200 SMD | 1 |
| DIGIKY | P75.0CCT | RES 75.0 OHM 0805 | 1 |
| DIGIKY | PCC2323CT | CAP 4.7 UF 16 V X5R 0805 | 1 |
| Various | 2023 | Lithium battery | 1 |

### Disposable Electronic Apparatus Elapsed Time Operation:

In elapsed time applications, the disposable electronic apparatus is energized at the manufacturing stage by insertion of the power cell (9), which contacts the printed circuit board (7) and completes the electrical circuit to the microprocessor (3). Additional time is added to elapsed time program to allow for the disposable electronic apparatus to be integrated with the intended product or service and for point of sale delivery. A single green flash and a single red flash from the LED (4) confirm that the self-test is complete. The microprocessor (3) initializes its internal hardware including the main timing circuitry (timer) that begins to oscillate under control of the crystal (1). Once the timing has stabilized, the microprocessor (3) begins to execute the stored program code which starts the timing interval to begin tracking time which has elapsed from when the disposable electronic apparatus was first energized. During the effective date time countdown, the LED (4) flashes green three times quickly if the sensor (10) is tripped to serve as visual confirmation that the effective date is still valid. Once all of the specified time for the intended application has been counted down, the microprocessor (3) can either be programmed to flash the LED (4) red and sound the optional audio alarm element (2) automatically or use the sensor (10) and the output pins to flash the LED (4) red and sound the optional audio alarm element (2) each time the disposable electronic apparatus is handled. A secondary timing function turns off activating alarms after a pre-determined amount of time. The disposable electronic apparatus can also be fitted with a temperature sensor (11) where accelerated or decelerated elapsed time notification is required based on ambient conditions.

### Disposable Electronic Apparatus—Compliance Operation

In compliance applications, the disposable electronic apparatus is energized when the circuit board barrier (8) is removed which allows the power cell (9) to contact the printed circuit board (7), which completes the electrical circuit to the microprocessor (3). A single green flash from the LED (4) and a single beep from the optional audio element (2) confirm that the self-test is complete. The microprocessor (3) then initializes its internal hardware including the main timing circuitry (timer) that begins to oscillate under control of the crystal (1). In applications where the alarm schedules are pre-programmed, once the timing has stabilized, the microprocessor (3) begins to execute the stored program code which starts timing the alarm intervals programmed in the code to activate single or multiple daily compliance alarms and uses the time of day the circuit board barrier (8) was removed as the reference starting point. At the same time, the microprocessor (3) also turns on the output pin(s) as required to flash the LED (4) and sound the optional audio element (2). The visual element (4) and optional audio element (2) indicate the alarm state until the end user picks up or handles the compliance product to trip the vibration sensor (10), which then ends the alarm cycle and turns off the LED (4) and optional audio alarm (2). Should the end user not trip the vibration sensor (10) by picking up or handling the compliance product within a pre-determined amount of time; a secondary timing function turns off active alarms automatically. The microprocessor (3) continues timing the pre-programmed compliance alarm schedule until that alarm period has expired at which time it loads the next alarm interval into its internal timer. The LED (4) and optional audio element (2) are then again turned on to indicate that the compliance product being monitored needs to be taken or administered. As before, the alarm activation interval continues until the vibration sensor (10) is tripped or the secondary automated timer has expired. This pre-programmed alarm schedule process continues until all of the pre-determined number of alarms for the intended compliance application have activated at which point no further alarm interval is loaded into the timer of the microprocessor (3). A reset switch (5) is provided to allow for alarm interval customization or re-initiation of the factory programmed alarm schedule. The reset switch (5) is accessed through a recess hole in the plastic embodiment (6) by inserting a paper clip end or similar object into recess hole and pressing and releasing the reset switch (5) to adjust alarm intervals as required. A visual flash from the LED (4) and/or audio beep from the optional audio element (2) confirms acceptance of the time adjustment made. An alarm adjusted to a time earlier than a pre-programmed alarm interval activates immediately upon the time adjustment. An alarm adjusted to a time later than a pre-programmed alarm interval takes effect 24 hours later. If the reset switch (5) is depressed and held for 5 seconds, all stored alarm times are erased and the specified pre-programmed alarm schedule starts anew.

In pharmacy dispensing applications, where pre-programmed alarm intervals cannot be used because of varying prescription requirements, the reset switch (5) of the Disposable Electronic Apparatus is reconfigured to allow for manual alarm setting by the end user. When the end user receives a prescription, he or she depresses the reset switch (5) each time tablets are taken over the first 24 hours of the prescription. The reset switch (5) can be depressed multiple times over the 24-hour period. The microprocessor (3) then memorizes each time the reset switch (5) was manually depressed over the first 24 hours and automatically activates alarms each day thereafter at those exact same times.

### Preferred Embodiments for the Disposable Electronic Apparatus

The disposable electronic apparatus can either be supplied encased in a translucent plastic embodiment (6) for external attachment to an existing time sensitive product or service or compliance product or supplied or insert molded to form a replacement plastic part for an existing product. Either method of embodying the disposable electronic apparatus will incorporate an optical element, which will efficiently guide incident rays of a single light source throughout the plastic translucent embodiment by employing inner reflections of a transparent acrylic resin. The translucent plastic embodiment (6) can be fabricated in a variety of different shapes and sizes to match the physical characteristics of an existing product container and to blend in with the overall cosmetic look.

### General Operating Specifications

All applications for the disposable electronic apparatus will use a lithium battery (9) of varying capacities. Timing accuracy in both elapsed time and compliance applications is + or −1%. Current life span for elapsed time monitoring and notification applications is up to 36 months. Current life span for compliance applications is up to 320 visual alarms or up to 230 visual and audio alarms. The sensor (10) is a surface mount device, which acts like a normally closed switch when at rest. The sensor (10) chatters open and closed as it is tilted or vibrated regardless of how it is mounted or aligned.

### Disposable Electronic Apparatus—Additional Information

Base Model—A visual alarm comes standard for all applications of the base model of the disposable electronic apparatus. Red is allocated as the flash color for elapsed time monitoring and notification applications and green is allocated as the flash color for compliance notification applications. All applications of the disposable electronic apparatus, except elapsed time applications where alarms are programmed to activate automatically, come with a motion sensor or vibration sensor. The intended application determines which function the sensor performs when tripped. In elapsed time monitoring and notification perishable product applications, once a product has surpassed its specified effective date, the sensor turns on a flashing red indicator and optional audio alarm (if incorporated) each time an expired product is picked up or handled. In compliance notification applications, the sensor turns off activating alarms when a product is picked up or handled during the active alarm. Compliance notification applications include a reset button that enables pre-programmed alarm time adjustments, manual alarm setting or complete alarm erasure if required.

Housing Options—The disposable electronic apparatus can either be encased in a plastic housing for external attachment to a perishable or compliance product or molded with plastic to form a replacement part of an existing product's container. All plastic housings will incorporate an optical element, which will efficiently guide incident rays of a single light source throughout all or a portion of the housing.

Energizing the Disposable Electronic Chip—In elapsed time monitoring and notification applications, the disposable electronic apparatus is energized at the time of manufacture. Additional time is added to the timer of the disposable electronic apparatus to allow product manufacturers sufficient time to integrate the technology with their respective product line and make delivery to their distribution networks. In compliance notification applications, the disposable electronic apparatus is energized when the end user removes a plastic pull-tab that allows the battery contacts of the circuit board to engage a power cell. In applications where the alarm schedules are pre-programmed, removal of the plastic pull-tab determines the daily start time.

Audio Alarm Option—An audio alarm can be incorporated into the disposable electronic apparatus design if audible notification is required.

Temperature Sensor Option—The disposable electronic apparatus can be fitted with a temperature sensor for elapsed time monitoring and notification applications where accelerated or decelerated elapsed time notification is required based on ambient conditions.

### Elapsed Time Monitoring & Notification Sample

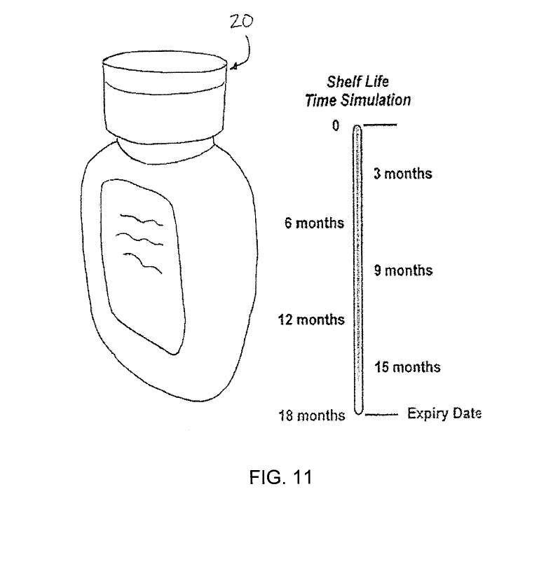

As shown in FIG. 11, the disposable electronic apparatus is molded with plastic to form a translucent bottle cap for an off-the-shelf perishable product container and the manufacturer has specified an eighteen-month shelf-life expiry date. The disposable electronic apparatus is programmed to count down the effective date range of the tablets for an eighteen-month period and begins this countdown once the additional allotted time for perishable product integration and distribution has elapsed. When the expiry date has been reached, the secondary function of the programming automatically activates and turns on a red visual alarm each time the product is picked up or handled to remind the consumer that the tablets inside the bottle have now expired and the perishable product should be replaced. This perishable product bottle sample image is for reference only. A perishable product manufacturer's existing bottle cap design as well as any industrial design modification will determine the actual finished look of a replacement bottle cap.

Other Potential Applications—Bulk tablet medication containers, chemicals, medical devices, laboratory applications or any other product or service that carries a short-term or long-term elapsed time monitoring and notification requirement.

### Compliance Notification Sample 1: Vitamin Bottle

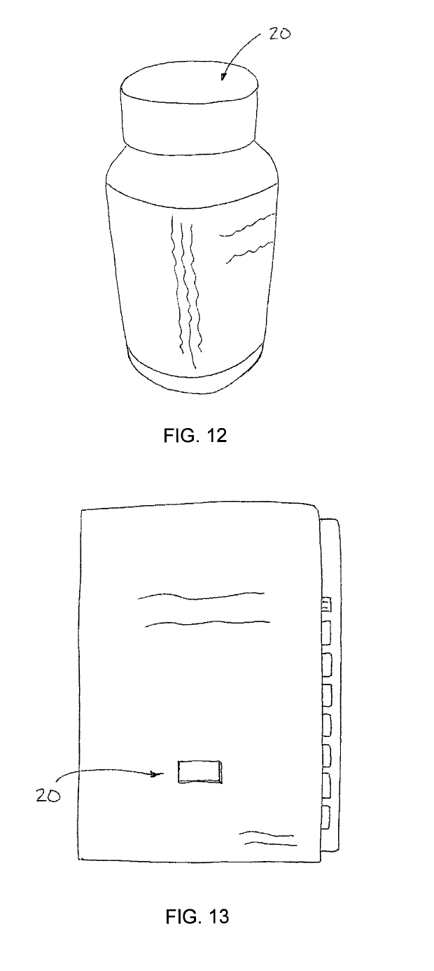

As shown in FIG. 12, the disposable electronic apparatus is molded to form a translucent bottle cap of a vitamin bottle containing 50 vitamins to be taken once a day. Once the vitamin bottle has been purchased, the power cell of the disposable electronic apparatus is energized by removing a plastic pull-tab, which is located with the protective packaging of the vitamin bottle cap. Upon removal of the plastic pull-tab, a green visual alarm illuminates once a day to remind the consumer to take the vitamin. The alarm is turned off when the consumer picks up the vitamin bottle to take the vitamin. The daily visual alarm activates at whatever time of day the plastic power cell tab was initially removed, for a total of 50 days. After the fiftieth alarm has activated, the chip would simply stop working and be discarded with the empty vitamin bottle. This vitamin bottle sample image is for reference only. The vitamin manufacturer's existing bottle cap design as well as well as any industrial design modification will determine the actual finished look of a replacement bottle cap.

### Compliance Notification Sample 2: Tablet Medication Blister Card

As shown in FIG. 13, the disposable electronic apparatus is encased in a plastic translucent housing and externally attached to a tablet medication blister card. The card consists of 28 pouches with each pouch holding a tablet medication dose. Once the plastic pull-tab has been removed to begin the prescription, the disposable electronic chip activates a pre-programmed visual and audio alarm four times/dosage intervals per day/cycle. After the last pouch of the blister card is emptied, the disposable electronic apparatus is then just transferred to a newly filled blister card. The disposable electronic apparatus will service 8 fully loaded blister cards over an eight-week period before replacement is required. This housing shown for external attachment of the disposable electronic apparatus is for reference only. Final industrial design of the plastic housing as well as the method of attaching the chip to the blister card will determine the actual finished look.

Other Potential Applications—Liquid medication bottles, prescription vials, birth control dispensers or any other product or service that requires assistance with compliance management.

Operation of a Compliance Sample Device with a 4 alarm per day pre-programmed schedule proceeds generally according to the following instructions:

1. Activating the 4 alarm per day Pre-programmed schedule—Remove the circuit board barrier to energize the circuit board and initiate the self test. A single green flash and audio beep confirms the self-test is complete. The removal of the circuit board barrier determines the start time of the pre-programmed schedule and predetermined alarm intervals. Therefore removal of the circuit board should only be done at the beginning of a prescription day. Take first dose of tablets upon completion of self-test.

2. 4 Alarms Per Day Pre-programmed Alarm Schedule—Once the circuit board barrier has been remove and the self-test is complete, the automated alarm schedule begins with the following alarm spacing or dosage time intervals.

1st alarm—set upon removal of circuit board barrier and then automatically at the same time of day circuit board barrier was initially removed each day thereafter.

2nd alarm—automatically 4.5 hours later

3rd alarm—automatically 5 hours later

4th alarm—automatically 4.5 hours later

3. Alarm Notification—A green flashing LED accompanied by an audio beep will activate and alarm for 60 seconds at each pre-programmed or manually adjusted alarm/dosage time at which point the subsequent dosage interval is automatically started.

4. Turning Off Activating Alarms—Automatically after 60 seconds or manually tripping the motion sensor or vibration sensor by picking up or handling the package will turn off the alarm indication.

5. Adiusting the Pre-programmed Alarm Intervals After the First 24 Hours—

Insert paper clip end or similar object into recess hole and press and re-
lease the reset switch to adjust alarm times as required. An audio beep
confirms acceptance of the time adjustment made. An alarm adjusted to a
time earlier than the pre-programmed alarm time will activate immediately
upon adjustment. An alarm adjusted to a time later than the pre-
programmed alarm will take effect in 24 hours after the adjustment is

| | Desired | Press | |
|---|---|---|---|
| Pre-programmed Schedule | New Times | Reset Switch | Takes Effect |
| 1st Alarm = 8:00 AM | 7:45 AM | 7:45 AM | Immediately |
| 20 Alarm = 12:30 PM | 1:00 PM | 1:00 PM | 24 hrs. Later |
| 3rd Alarm = 5:30 PM | 4:45 PM | 4:45 PM | Immediately |
| 4th Alarm = 10:00 PM | 10:15 PM | 10:15 PM | 24 hrs. Later |

6. Erasing All Pre-programmed and/or Adiusted Alarms—This is accomplished by inserting a paper clip end or similar object into the recess hole. Press and hold the reset switch down for 5 seconds to erase all alarms from memory. 5 short beeps confirm all alarms have been erased. Since this process, when complete, begins the pre-programmed schedule over again, it is recommended that total alarm erasure procedure only be preformed at the start of a prescription day and at the desired time the first dose is to be taken. For example, if the desired morning dose time is 9:15 AM, press and hold the reset switch for 5 seconds at 9:15 AM and then take first dose of tablets for the day.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A timing device for use with a consumable product, the device comprising:
a timer arranged for determining a time interval;
a sensor arranged to detect an interaction between a user and the consumable product;
an indicator arranged for indicating to the user a consumption characteristic related to consumption of the product;
a processor arranged to determine the consumption characteristic responsive to the timer and the sensor; and
a circuit board commonly supporting the timer, the sensor, the indicator and the processor thereon.

2. The device according to claim 1 in combination with a package containing the consumable product therein wherein the sensor comprises a movement sensor arranged to be supported on the package and detect movement of the package.

3. The device according to claim 1 wherein the indicator comprises a light and wherein there is provided a translucent housing supporting the timer, the sensor, the indicator and the processor therein, the translucent housing being arranged to reflect light from the indicator in plural directions.

4. The device according to claim 1 in combination with a package containing the consumable product therein wherein the timer, the sensor, the indicator, and the processor are encased by and integrally molded into a housing comprising a replacement component arranged for replacing a component of the package.

5. (canceled)

6. The device according to claim 1 wherein the sensor is arranged to detect a vibration movement of the sensor.

7. The device according to claim 1 wherein the processor is operable in a first mode in which the indicator is activated responsive to detection of user interaction once the time interval has expired and a second mode in which the indicator is activated responsive to the time interval being expired and in which the indicator is deactivated responsive to detection of user interaction.

8. The device according to claim 1 wherein the time interval corresponds to an expiration date of the product.

9. The device according to claim 8 wherein the indicator is only activated for a prescribed period of time responsive to detection of user interaction by the sensor.

10. The device according to claim 8 wherein the indicator is responsive to detection of user interaction by the sensor before expiry of the time interval.

11. The device according to claim 8 wherein the indicator responsive to detection of user interaction by the sensor after expiry of the time interval.

12. The device according claim 8 wherein the indicator comprises a first indicator which is responsive to detection of user interaction by the sensor before expiry of the time interval and a second indicator separate from the first indicator which is responsive to detection of user interaction by the sensor after expiry of the time interval.

13. The device according claim 8 wherein there is provided an auxiliary timer actuated responsive to activation of the indicator and arranged to prevent further activation of the indicator until expiry of a prescribed interval of the auxiliary timer.

14. The device according to claim 8 wherein the time interval includes a duration between a time of manufacture and packaging of the product and a duration of a shelf life of the product from the packaging of the product.

15. The device according to claim 8 wherein there is provided a temperature sensing module arranged for connection to the processor, the temperature sensing module being arranged to sense an ambient temperature and to alter the time interval according to the ambient temperature.

16. The device according to claim 1 wherein the time interval comprises an interval of time between dosages of the product, the indicator being activated responsive to the time interval being expired and being deactivated responsive to detection of user interaction, and the processor being arranged to restart the timer upon each activation of the indicator.

17. The device according to claim 16 wherein there is provided an auxiliary timer arranged to deactivate the indicator once the indicator has been activated for a prescribed duration of the auxiliary timer.

18. The device according claim 16 wherein the processor is arranged to determine when a prescribed number of dosages has been reached and discontinue further activation of the indicator when the prescribed number of dosages has been reached.

19. The device according to claim 16 wherein there is provided a reset switch in communication with the processor and wherein there is provided a plurality of different time intervals corresponding to different intervals of time between different dosages within a prescribed cycle, the reset switch being arranged to both alter a duration of the different time intervals and reset a starting point of the prescribed cycle.

20. The device according to claim 16 wherein there is provided a reset switch in communication with the processor and wherein the processor is operable in a programming mode in which each actuation of the reset switch over a 24 hour programming period determines a corresponding dosage interval in a subsequent 24 hour operating period in an operating mode in which the indicator is responsive to expiry of each dosage interval.

21. A timing device for use with a consumable product, the device comprising:
a timer arranged for determining a time interval;
a movement sensor arranged to be supported on a package of the consumable product and to detect movement of the package;
an indicator arranged for indicating to the user a consumption characteristic related to consumption of the product; and
a processor arranged to determine the consumption characteristic responsive to the timer and the movement sensor.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)
